(19) United States
(12) Patent Application Publication
(10) Pub. No.: US 2007/0032157 A1
(43) Pub. Date: Feb. 8, 2007

(54) Dually dispersed fiber construction for nonwoven mats using chopped strands

(76) Inventors: Ralph D. McGrath, Granville, OH (US); William G. Hager, Westerville, OH (US); David E. Weller JR., Newark, OH (US); Leonard J. Adzima, Pickerington, OH (US)

Correspondence Address: OWENS CORNING, 2790 COLUMBUS ROAD, GRANVILLE, OH, 43023, US

(21) Appl. No.: 11/197,983

(22) Filed: Aug. 5, 2005

(51) Int. Cl. B31B 1/60; D04H 13/00; D04H 1/00; D02G 3/00; F16J 15/20; B32B 5/26; B32B 25/20

(52) U.S. Cl. 442/381; 442/327; 442/357; 442/391; 442/392; 428/359; 428/364; 428/365; 428/375; 428/391; 156/60

(57) ABSTRACT

A chopped strand mat formed of bundles reinforcin fibers and individual reinforcing fibers is provided. The chopped strand mat may be engineered to contain pre-selected amounts of bundles of reinforcement fibers and/or individual reinforcement fibers to select or enhance a particular feature of the chopped strand mat. In at least one embodiment, the reinforcing fibers are wet use chopped strand glass fibers. The reinforcing fibers are at least partially coated with a size composition that maintains bundle integrity during the formation of the mat and assists in filamentizing the bundles during subsequent processing steps in order to form chopped strand mat that gives an aesthetically pleasing look to the finished product. The retention of fiber bundles within the chopped strand mat creates a mat with a higher glass content per volume than conventional dispersed fiber mats. This increased glass content provides improved mechanical and impact performance to the final products.

### TECHNICAL FIELD AND INDUSTRIAL APPLICABILITY OF THE INVENTION

The present invention relates generally to non-woven fibrous mats, and more particularly, to a chopped strand mat that is formed of individual reinforcement fibers and bundles of reinforcing fibers. A method of making the chopped strand mat is also provided.

### BACKGROUND OF THE INVENTION

Glass fibers are useful in a variety of technologies. For example, glass fibers are commonly used as reinforcements in polymer matrices to form glass fiber reinforced plastics or composites. Glass fibers have been used in the form of continuous or chopped filaments, chopped strands, rovings, woven fabrics, non-woven fabrics, meshes, and scrims to reinforce polymers.

Typically, glass fibers are formed by drawing molten glass into filaments through a bushing or orifice plate and applying an aqueous sizing composition containing lubricants, coupling agents, and film-forming binder resins to the filaments. The sizing composition provides protection to the fibers from interfilament abrasion and promotes compatibility between the glass fibers and the matrix in which the glass fibers are to be used. After the sizing composition is applied, the fibers may be gathered into one or more strands and wound into a package or, alternatively, the fibers may be chopped while wet and collected. The collected chopped strands may then be dried and cured to form dry chopped fibers or they can be packaged in their wet condition as wet chopped fibers.

Fibrous mats, which are one form of fibrous non-woven reinforcements, are extremely suitable as reinforcements for many kinds of synthetic plastic composites. Dried chopped glass fiber strands (DUCS) are commonly used as reinforcement materials in thermoplastic articles. These dried chopped glass fibers may be easily fed into conventional machines and may be easily utilized in conventional methods, such as dry-laid processes. In a conventional dry-laid process, dried glass fibers are chopped and air blown onto a conveyor or screen and consolidated to form a mat. For example, dry chopped fibers and/or polymeric fibers are suspended in air, collected as a loose web on a screen or perforated conveyor, and then consolidated to form a mat of randomly oriented fibers.

Wet chopped fibers are conventionally used in a wet-laid process in which the wet chopped fibers are dispersed in a water slurry that contains surfactants, viscosity modifiers, defoaming agents, and/or other chemical agents. Once the chopped glass fibers are introduced into the slurry, the slurry is intensely agitated so that the fibers become dispersed. The slurry containing the fibers is deposited onto a moving screen where a substantial portion of the water is removed to form a web. A binder is then applied, and the resulting mat is dried to remove any remaining water and cure the binder. The formed non-woven mat is an assembly of dispersed, individual glass filaments. Wet-laid processes are typically used when a uniform distribution of fibers and/or weight is desired.

On the other hand, dry-laid processes are particularly suitable for the production of highly porous mats (e.g., low density) and are suitable where an open structure is desired in the mat to allow the rapid penetration of various liquids or resins. Unlike wet-laid mats, dry-laid mats are formed of bundles of fibers and, as a result, can have a higher basis weight than wet-laid mats. A conventional chopped strand mat is depicted pictorially in FIG. 1. Unfortunately, conventional dry-laid processes tend to produce mats that do not have a uniform weight distribution throughout their surface areas, especially when compared to mats formed by conventional wet-laid processes. In addition, the use of dry chopped fibers can be more expensive to process than the wet chopped fibers used in wet-laid processes because the dry chopped fibers are generally dried and packaged in separate steps before being chopped.

For certain reinforcement applications in the formation of composite parts, it is desirable to form fiber mats in which the mat includes an open, porous structure (as in a dry-laid process) and which has a uniform weight (as in a wet-laid process). In this regard, fibrous mats have been formed that contain both individual glass fibers (as is found in a wet-laid process) and bundles of glass fibers (as is found in a dry-laid process) in an attempt to create a mat that contains desirable features of both wet-laid and dry-laid mats. Some examples of these mats are set forth below.

U.S. Pat. Nos. 4,112,174 and 4,129,674 to Hannes et al. disclose glass mats that are formed of a web of monofilament fibers and elongated glass fiber bundles interspersed throughout the web in a randomly oriented pattern. The glass fiber bundles preferably contain from about 20-300 monofilaments. The fibrous mats are formed by wet-laid processes. A water slurry is formed that includes base fibers and reinforcement fibers such that the solids content of the slurry is low. The slurry is deposited onto a moving screen where a majority of the water is removed to form a web. After the formation of a web of monofilaments and elongated glass fiber bundles, a binder substance is added to assist in holding the monofilament fibers and reinforcement bundles together. The web is then passed through a dryer to evaporate any remaining water and cure the binder.

U.S. Pat. Nos. 4,200,487 and 4,242,404 to Bondoc et al. describe glass mats that include individual glass filaments and extended glass fiber elements. The mats are formed by a wet-laid process. The individual filaments appear by conventional filamentation of the fiber bundles. The extended glass fiber elements are formed from by longitudinal extension of a given bundle whose fibers are connected longitudinally. In particular, during agitation in the white water slurry, the some fibers from the fiber bundles become filamentized (form individual filaments). The remaining fibers in the in a partially filamentized bundles (or fibers in an original unfilamentized bundle) then slide apart and become connected longitudinally to form an extended glass fiber element. As a result, the fiber elements have an effective length that exceeds that of the individual fibers. In addition, the fiber elements have a diameter that is greater in the middle than it is at the ends of the fiber elements. It is asserted that the glass fiber elements contribute to high strength properties of the mat and that the individual filaments provide a uniform denseness necessary for the impregnation of asphalt in the manufacturing of roofing shingles.

U.S. Pat. No. 5,883,021to Beer et al. discloses a vacuum molding-compatible mat that includes glass monofilaments and glass fiber strands substantially uniformly distributed throughout the mat. Preferably, the glass monofilaments are present in an amount from about 30-99% by weight on a total solids basis. In addition, at least a portion of the glass monofilaments are entangled with the glass fiber strands. The glass fiber strands may contain about 5-150 generally parallel cohesive glass fiber monofilaments that resist separation. The fibrous mat is formed by an air-laid process.

U.S. Pat. No. 5,883,023 to Martine et al. describes a needled mat that includes discontinuous glass monofilaments and discontinuous glass fiber strands. The glass monofilaments are present in the mat in an amount of at least about 30 weight percent to about 99 weight percent on a total solids basis. The glass fiber strands have at least about 100 generally parallel glass fiber monofilaments. The glass monofilaments and glass fiber strands are substantially evenly distributed throughout the mat. The mat is made by an air-laid process.

U.S. Pat. No. 6,187,697 to Jaffee et al. describes a two layer fibrous mat formed of (1) a body portion layer and (2) a surface portion layer that includes fine fibers and/or particles. The layers are bonded together with a resin binder. Preferably, most of the particles and/or fibers in the surface layer are larger than the openings between the fibers in the body portion of the mat. The mats are made on a wet laid non-woven mat machine.

U.S. Pat. No. 6,767,851 and U.S. Patent Application Publication No. 2002/0092634 to Rokman et al. disclose non-woven mats in which at least 20% of the fibers are present as fiber bundles having about 5-450 fibers per bundle. In preferred embodiments, at least 85% of the fibers in the mats are in the form of bundles. The fibers are held in the bundles by a substantially non-water soluble sizing such as an epoxy resin or PVOH. In addition, the bundles may comprise at least 10% reinforcing fibers such as glass fibers. The mat may be made by a foam or water process, although a foam process is preferred. In particular, a slurry of fibers is formed in a liquid or foam where at least 20% of the fibers in the slurry are fiber bundles held together by a non-water soluble sizing. A binder may be added to the slurry, the foam or water is removed from the slurry to form a web, and the binder is subsequently cured to increase the integrity of the mat produced.

Despite the attempts to form an improved mat that contains the features of wet-laid and dry-laid mats, there exists a need in the art for a cost-effective and efficient process for forming a non-woven mat which has a substantially uniform weight distribution, and which has an open, porous structure that can be used in the production of reinforced composite parts that overcomes the disadvantages of conventional wet-laid and dry-laid processes.

### SUMMARY OF THE INVENTION

It is an object of the present invention to provide a chopped strand mat that contains both bundles of reinforcement fibers individual reinforcement fibers. The chopped strand mat can be formed with varying amounts of bundles of reinforcement fibers and/or individual reinforcement fibers to select or enhance a particular feature of the chopped strand mat. In addition, the chopped strand mat can be engineered (controlled) to have a predetermined amount of reinforcement fiber bundles and individual reinforcement fibers to form a mat with a desired ratio and weight distribution. The specific number of fibers present in the reinforcing fiber bundles will vary depending on the particular application of the chopped strand mat and the desired strength and thickness of the mat. It is preferred that the reinforcing fiber bundles have a bundle tex of from about 20 to about 75 g/km. The reinforcing fibers suitable for use in the chopped strand mat include glass fibers, wool glass fibers, natural fibers, mineral fibers, carbon fibers, and ceramic fibers. The reinforcing fibers are at least partially coated with a size composition that maintains bundle integrity during the formation of the mat and assists in filamentizing the bundles during subsequent processing steps in order to form a mat that gives an aesthetically pleasing look to the finished product. The size composition may be applied to the fibers with a Loss on Ignition (LOI) of from about 0.05 to about 2.0% on the dried fiber. The retention of fiber bundles within the chopped strand mat creates a mat with a higher glass content than conventional dispersed fiber mats. In turn, this increased glass content provides improved mechanical and impact performance to the final products.

It is also an object of the present invention to provide a method of making a chopped strand mat that is formed of reinforcing fiber bundles and individual reinforcement fibers. Glass fibers are at least partially coated with a sizing composition that includes at least one film forming agent (e.g., polyurethane film formers, polyester resin film formers, and epoxy resin film formers), a lubricant (e.g., Lubesize K-12), and a silane coupling agent (e.g., an aninosilane). Optionally, a weak acid (e.g., acetic acid) may be added to assist in the hydrolysis of the silane coupling agent. The size composition can maintain bundle integrity during the formation of the mat and allow filamentation of the bundles during subsequent processing steps. After the fibers are treated with the sizing composition, they are collected as bundles of fibers, chopped into discrete lengths, and dried. Preferably, the bundles are dried in a dielectric oven or a Cratec® oven. The dried fiber bundles are dispersed in a water slurry that contains surfactants, viscosity modifiers, and/or other chemical agents, and agitated. In at least one exemplary embodiment, as the glass fiber bundles are agitated within the slurry, some of the bundles of glass fibers release individual glass fibers. In another exemplary embodiment, the fiber bundles may be sized with the sizing composition so that little or no fibers disperse from the fiber bundles in the slurry during agitation. In this embodiment, individual fibers may be added in known amounts to the white water slurry to form a chopped strand mat having a desired morphology. Because the amount of individual fibers present within the slurry can be controlled, the chopped strand mat may be fine tuned to meet the needs of a particular application. The slurry is then deposited onto a moving screen where a majority of the water is removed to form a web, a binder is applied, and the web is dried to remove the remaining water and cure the binder. The formed non-woven chopped strand mat is an assembly of a pre-determined amount of randomly dispersed, individual glass fibers and glass fiber bundles.

It is a further object of the present invention to provide a sizing composition that includes a film forming agent to hold the fibers in bundles, a lubricant to assist in reducing fiber-to-fiber abrasion, and a silane coupling agent to bond the glass fibers to the laminate resin matrix. A weak acid such as acetic acid may be added to the size composition to assist in the hydrolysis of the silane coupling agent. Non-limiting examples of chemicals useful in the sizing composition include film formers such as polyurethane film formers, epoxy resin film formers, and unsaturated polyester resin film formers; lubricants such as Lubesize K-12 (a stearic ethanolamide available from AOC) and PEG 400 MO (a monooleate ester available from Cognis); and silanes such as aminosilanes. Specific examples of suitable size compositions that are effective in maintaining bundle integrity during the formation of the mat include urethane-based film forming dispersions in combination with aminosilanes (and optionally a polyurethane-acrylic alloy) and epoxy-based film former dispersions in combination with epoxy curatives (and optionally an epoxy curative).

It is an advantage of the present invention that the retention of fiber bundles allows for the chopped strand mat to have a higher glass content per volume than conventional dispersed fiber mats.

It is a further advantage of the present invention that the glass fibers forming the chopped strand mat can be formed and chopped in a one-step process.

It is another advantage of the present invention that the increased glass content imparted by the chopped strand mats provides improved mechanical and impact performance and higher integrity in the final products.

It is yet another advantage of the present invention that the chopped strand mat may be used to form surface treatments for products such as duct liners and ceiling tiles without the need to apply a secondary veil.

It is also an advantage of the present invention that the final morphology of the chopped strand mat can be adjusted by chemical and/or mechanical methods to provide ranges of dispersion of the fiber strands and fiber bundles in the chopped strand mat.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a photographic depiction of a conventional chopped glass fiber mat;

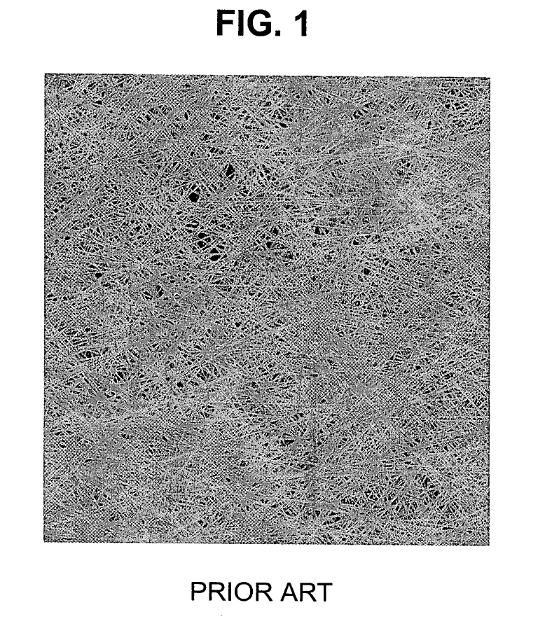

FIG. 2 is an enlarged partial perspective view of a chopped glass fiber mat formed of bundles of glass fibers and individual glass fibers according to at least one exemplary embodiment of the present invention;

FIG. 3 is a photographic depiction of a chopped strand mat according to at least one exemplary embodiment of the present invention;

FIG. 4 is a graphical illustration of the laminate tensile strengths in the machine direction and the cross direction for conventional chopped strand mats and chopped strand mats according to the instant invention; and

FIG. 5 is a graphical illustration of the laminate flexural strengths in the machine direction and the cross direction for conventional chopped strand mats and chopped strand mats according to the instant invention.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references.

In the drawings, the thickness of the lines, layers, and regions may be exaggerated for clarity. It is to be noted that like numbers found throughout the figures denote like elements. It will be understood that when an element is referred to as being “on,” another element, it can be directly on or against the other element or intervening elements may be present. The terms “reinforcement fibers” and “reinforcing fibers” may be used interchangeably herein. In addition, the terms “sizing”, “size”, “sizing composition”, and “size composition” may be interchangeably used.

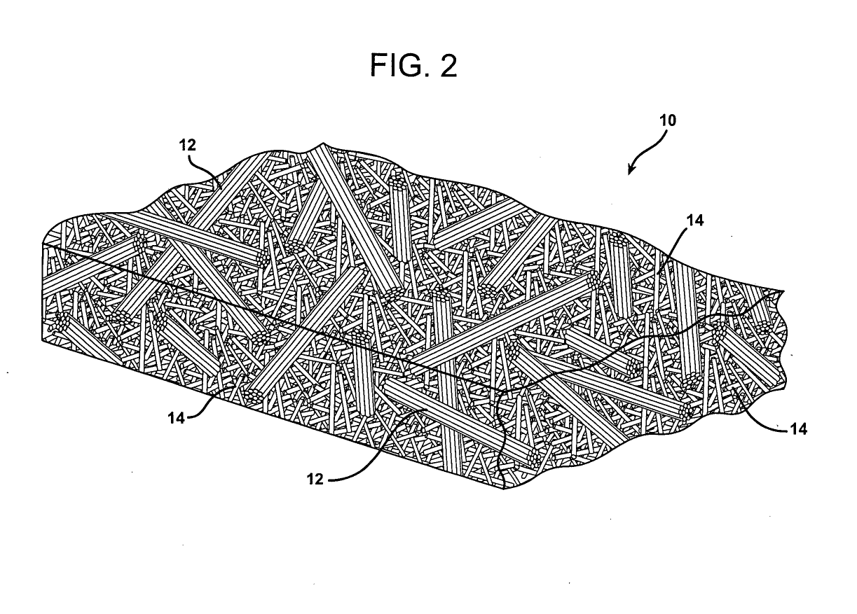

The present invention relates to a chopped strand mat that is formed of bundles of reinforcing fibers and discrete (e.g., individual) reinforcing fibers and a method of making such a mat. As depicted generally in FIG. 2, the chopped strand mat 10 includes bundles of reinforcement fibers 12 and individual reinforcement fibers 14 positioned throughout the chopped strand mat 10 in a random orientation. The chopped strand mat 10 is a combination of an open porous structure, which is typical of the bundles of fibers found in conventional dry-laid mats, and a less permeable structure that is typical of the close-packed array of individual fibers or filaments found in conventional wet-laid veils.

The chopped strand mat 10 can be formed with varying amounts of bundles of reinforcement fibers 12 and/or individual reinforcement fibers 14 to create a chopped strand mat 10 that combines desirable features of both wet-laid and dry-laid mats and allows for the selective enhancement a particular feature(s) of wet-laid or dry-laid mats. The chopped strand mat 10 is a low loft, non-woven mat that may be used in a myriad of applications where higher structural integrity, higher tensile strength, or higher burst strength is required, such as, for example, in roofing, building, and automotive products, door skins, boat hulls, table surfaces, serving trays, containers, reinforced surface treatments for fibrous insulation, and duct liner products.

The reinforcing fibers may be any type of organic, inorganic, or natural fiber suitable for providing good structural qualities and durability. Examples of suitable reinforcing fibers include glass fibers, wool glass fibers, natural fibers, mineral fibers, carbon fibers, and ceramic fibers. The term “natural fiber” as used in conjunction with the present invention refers to plant fibers extracted from any part of a plant, including, but not limited to, the stem, seeds, leaves, roots, or bast. The reinforcing fibers forming the chopped strand mat may include only one type of reinforcement fiber (such glass fibers) or, alternatively, more than one type of reinforcement fiber may be used in forming the chopped strand mat. The inclusion of synthetic fibers or polymer resins such as polyester, polyethylene, polypropylene and the like in the chopped strand mat is considered to be within the purview of the invention. The addition of a synthetic fiber or polymer resin may be used to create in a one-step process a pre-form of a coated or filled chopped strand mat that may then be used in conventional close-molding processes that utilize such pre-forms commonly referred to as sheet molding compounds. In addition, the presence of synthetic fibers in the chopped strand mat may enhance the tensile strength of the mat.

In preferred embodiments, all of the reinforcing fibers are glass fibers. Any type of glass fiber, such as A-type glass fibers, C-type glass fibers, E-type glass fibers, S-type glass fibers, AR-type glass, ECR-type glass fibers (e.g., Advantex® glass fibers commercially available from Owens Corning), or modifications thereof may be used as the reinforcing fibers. In at least one preferred embodiment, the reinforcing fibers are wet use chopped strand glass fibers (WUCS). Wet use chopped strand glass fibers for use as the reinforcement fibers may be formed by conventional processes known in the art. It is desirable that the wet use chopped strand glass fibers have a moisture content of from about 5 to about 30%, and even more desirably a moisture content of from about 5 to about 15%. In addition, the presence of the single reinforcement fibers improves the wet strength of the mat prior to curing the binder.

The reinforcing fibers that form the reinforcing fiber bundles 12 and individual reinforcing fibers 14 may be chopped fibers having a length of about 0.25 to about 3.0 inches, and preferably about 0.25 to about 1.25 inches. In addition, the reinforcing fibers may have diameters of about 8 to about 23 microns, preferably from about 12 to about 16 microns. Additionally, the reinforcing fibers may have varying lengths and diameters from each other within the chopped strand mat. The reinforcement fibers may be present in the chopped strand mat 10, in the form of bundles 12 and individual fibers 14, in an amount of from about 0 to about 99% by weight of the final product.

In addition, the chopped strand mat 10 may be formed of about 0 to about 100% by weight (based on the total fibers) of reinforcement fiber bundles and from about 0 to about 100% by weight (based on the total fibers) of individual reinforcement fibers. The proportional amount of the individual fibers 14 and reinforcement fiber bundles 12 will vary depending on the desired application of the chopped strand mat 10. For example, in an application where there is a minor requirement for surface quality and a higher structural requirement (such as in a boat hull), a very high number of reinforcement fiber bundles 12 (such as ≧about 95% by weight) may be present in the chopped strand mat 10. Alternatively, for a less structurally demanding, but more surface conscious component such as a surface tray or an automotive parcel shelf, the chopped strand mat 10 may have a larger amount of individual reinforcement fibers 14 (such as ≧about 30% by weight)

The chopped strand mat 10 may be formed by the wet-laid process described below. It is to be noted that the exemplary process is described with respect to a preferred embodiment in which the reinforcement fibers are glass fibers. As is known in the art, glass fibers may be formed by attenuating streams of a molten glass material from a bushing or orifice. An aqueous sizing composition is applied to the fibers after they are drawn from the bushing. The sizing may be applied by application rollers or by spraying the size directly onto the fibers. Generally, the size protects the fibers from breakage during subsequent processing, helps to retard interfilament abrasion, and ensures the integrity of the strands of glass fibers, e.g., the interconnection of the glass filaments that form the strand.

In the present invention, the size on the glass fibers also maintains bundle integrity during the formation and processing of the fiber bundles prior to the addition of the bundles to the white water slurry and when the bundles are added to the white water slurry and agitated in the wet-laid process as described below. In addition, the size on the chopped fibers assists in filamentizing the bundles in the chopped strand mat during subsequent processing steps (such as molding the chopped strand mat) to form an aesthetically pleasing finished product. The sizing composition permits for a quick filamentizing of the fiber bundles during the subsequent processing steps to form a final product, and, as result, a fast wet out of the fibers. The selective dispersion of the reinforcement fibers may be accomplished by the choice of components in the size composition and/or the amount of size composition applied to the glass fibers.

The sizing composition includes one or more film forming agents to hold the fibers in bundles, a lubricant to assist in reducing fiber-to-fiber abrasion, and a silane coupling agent to bond the glass fibers to the laminate resin matrix. When needed, a weak acid such as acetic acid, boric acid, metaboric acid, succinic acid, citric acid, formic acid, and/or polymeric acids such as polyacrylic acids may be added to the size composition to assist in the hydrolysis of the silane coupling agent. The size composition may be applied to the fibers with a Loss on Ignition (LOI) of from about 0.05 to about 2.0% on the dried fiber. LOI may be defined as the percentage of organic solid matter deposited on the glass fiber surfaces.

Film formers are agents which create improved adhesion between the reinforcing fibers, which results in improved strand integrity. Suitable film formers for use in the present invention include polyurethane film formers, epoxy resin film formers, and unsaturated polyester resin film formers. Specific examples of film formers include, but are not limited to, polyurethane dispersions such as Neoxil 6158 (available from DSM); polyester dispersions such as Neoxil 2106 (available from DSM), Neoxil 9540 (available from DSM), and Neoxil PS 4759 (available from DSM); and epoxy resin dispersions such as PE-412 (available from AOC), NX 9620 (available from DSM), Neoxil 0151 (available from DSM), Neoxil 2762 (DSM), NX 1143 (available from DSM), and AD 502 (available from AOC). The film former(s) may be present from to about 5 to about 90% by weight of the active solids in the size composition, preferably from about 40 to about 80% by weight of the active solids.

The size composition includes one or more silane coupling agents. Silane coupling agents enhance the adhesion of the film forming copolymer to the glass fibers and to reduce the level of fuzz, or broken fiber filaments, during subsequent processing. Examples of silane coupling agents which may be used in the present size composition may be characterized by the functional groups amino, epoxy, vinyl, methacryloxy, ureido, isocyanato, and azamido. Suitable coupling agents for use in the size composition are available commercially, such as, for example, γ-aminopropyltriethoxysilane (A-1100 available from General Electric) and methacryloxypropyltriethoxysilane (A-174 available from General Electric). The aminosilane coupling agent is present in the size composition in an amount of from about 5 to about 30% by weight of the active solids in the size composition, and even more preferably, in an amount of from about 10 to about 15% by weight of the active solids.

In addition, the size composition may include at least one lubricant to facilitate manufacturing. The lubricant may be present in an amount of from about 0 to about 15% by weight of the active solids in the size composition. Preferably, the lubricant is present in an amount of from about 5 to about 10% by weight of the active solids. Any suitable lubricant may be used. Lubricants suitable for use in the size composition include, but are not limited to, stearic ethanolamide, sold under the trade designation Lubesize K-12 (available from AOC) and PEG 400 MO (available from Cognis), a monooleate ester having about 400 ethylene oxide groups.

It has been discovered that certain families of chemistry in combination are especially effective in causing the fiber bundles to remain in a bundle form in the white water slurry. For example, urethane-based film forming dispersions in combination with aminosilanes, such as, for example,γ-aminopropyltriethoxysilane (sold as A-1100 by General Electric) are effective in the size composition to keep the bundled fibers together. Adding an additive such as a polyurethane-acrylic alloy to the urethane-based sizing composition has also been found to help maintain bundle integrity.

Additionally, epoxy-based film former dispersions in combination with epoxy curatives are effective sizing compositions for use in the present invention. In particular, an epoxy-based film former such as Epi-Rez 5520 and an epoxy curative such as DPC-687 available from Resolution Performance Products forms an effective sizing composition, particularly in combination with a methacryloxy silane such as methacryloxypropyltriethoxysilane (commercially available as A-174 from General Electric).

Further, unsaturated polyester resin film formers have been found to be effective in forming a useful sizing composition. For example, an unsaturated polyester resin film former such as PE-412 (an unsaturated polyester in styrene that has been emulsified in water (AOC)) or Neoxil PS 4759 (available from DSM) are effective sizes for use in the instant invention. Unsaturated polyester film formers may be used alone or in combination with a benzoyl peroxide curing catalyst such as Benox L-40LV (Norac Company, Inc.). The benzoyl peroxide curing catalyst catalyzes the cure (crosslinking) of the unsaturated polyester resin and renders the film surrounding the glass fibers water resistant.

The sizing composition utilized may optionally contain conventional additives including antifoaming agents such as Drew L-139 (available from Drew Industries, a division of Ashland Chemical), antistatic agents such as Emerstat 6660A (available from Cognis), surfactants such as Surfynol 465 (available from Air Products), Triton X-100 (available from Cognis), and/or thickening agents. Additives may be present in the size composition from trace amounts (such as <about 0.1% by weight of the active solids) up to approximately 5% by weight of the active solids.

After the fibers are treated with the sizing composition, they are collected as bundles of fibers and chopped into discrete lengths. The fiber bundles are formed of a plurality of the chopped glass fibers positioned in a substantially parallel orientation to each other. The specific number of individual fibers present in the reinforcing fiber bundles will vary depending on the particular application of the chopped strand mat and the desired strength and thickness of the mat. The reinforcing fiber bundles may have a bundle tex of from about 20 to about 500 g/km, preferably from about 20 to about 75 g/km, and even more preferably from about 30 to about 50 g/km.

The bundles of wet, sized chopped glass fibers are then dried to consolidate or solidify the sizing composition. Preferably, the bundles of fibers are dried in a conventional dielectric (RF) oven, a fluidized bed oven such as a Cratec® oven (available from Owens Corning), or a standard rotating tray thermal oven. It is preferred that substantially all of the water is removed by the drying oven. It should be noted that the phrase “substantially all of the water” as it is used herein is meant to denote that all or nearly all of the free water from the fiber bundles is removed. In exemplary embodiments, greater than about 99% of the free water (water that is external to the reinforcement fibers) is removed. The dried bundles of fibers are then dispersed in a water slurry which may contain surfactants, viscosity modifiers, or other chemical agents, and agitated to disperse the reinforcement fiber bundles throughout the slurry. It is to be appreciated that bundles of chopped reinforcement fibers may be individually formed and deposited in the aqueous slurry.

In at least one exemplary embodiment, as the glass fiber bundles are agitated within the slurry, some of the bundles of glass fibers release individual glass fibers. These individual glass fibers are dispersed along with the bundles of fibers throughout the slurry. In addition to the released fibers, other types individual reinforcement fibers may be added to the slurry if additional types reinforcement fibers are desired in the final product. The amount of dispersion, or the amount of individual fibers released, is at least a function of the specific film former in the sizing composition, the white water chemistry, and the mat formation conditions. For example, the amount of shear the fiber bundles encounter in the mixing tank by the mixer, the length of time the bundles are in the white water slurry, the force of the vacuum that removes a portion of the water prior to the drying/curing oven, and the amount of heat applied by the drying/curing oven may effect whether or not individual fibers are released or dispersed from the fiber bundles. In addition, the ingredients or individual components of the sizing composition may have an effect on the amount of fibers, if any, are released.

The film forming ingredient of the size is a primary driver of what degree of filamentation (dispersion of fibers from the bundles) occurs. In particular, both the type and the amount of film former present on the glass fibers plays a role in the degree of filamentation of the glass bundles. The film former applied to the glass fibers should be resistant to the process in which it is to be employed if the bundles are to remain in a bundle form. For example, if a thermosetting film former such as an epoxy film former is utilized in the size and is applied to the glass fibers, which are subsequently bundled and cured in a drying oven, the bundled glass fibers will have little tendency to filamentize because the film former is crosslinked and generally impervious to water. On the other hand, if too little film former is added to the size applied to the glass strands, even if the film former is a film former that normally displays excellence resistance to water, such as an epoxy film former, the small amount of film former may permit the fiber bundles to filamentize and release individual fibers because the size coating is not complete over the fiber bundles. A water soluble film former, such as polyvinylacetate, will permit the fiber bundles to filamentize no matter how much film former is added to the size and applied to the glass fibers due to the water solubility of the size.

In addition, the silane coupling agent and lubricant may have an effect on the amount of fibers released from the fiber bundles. For instance, a methacryloxysilane coupling agent such as A-174 from General Electric may form stiff, poor filamentizing bundles. On the other hand, the presence of a lubricant may enhance the tendency of the bundles to filimentize by making the coating susceptible to water. Thus, by altering the mechanical mat forming conditions and/or the components and/or amounts of the sizing composition, chopped strand mats can be formed (engineered) with predetermined amounts of fiber bundles and individual fibers.

In an alternative embodiment, the fiber bundles may be sized with the sizing composition so that none, or substantially none, of the fibers disperse from the fiber bundles in the white water slurry during agitation. The phrase “substantially none” is meant herein to denote that no individual fibers or nearly no individual fibers, are released from the fiber bundles. For example, and as discussed above, the glass fibers may remain in a bundle throughout the mat forming process if the size applied to the fibers contains a crosslinkable film former such as an epoxy film former because the crosslinking of the film former during heating renders the fiber bundles resistant to water. In this alternate embodiment, individual fibers may be added in known, predetermined amounts to the white water slurry to form a chopped strand mat that has a desired morphology. As with the reinforcing fibers forming the fiber bundles, the individual fibers added to the slurry may have a chop fiber length of from about ¼ to about 3 inches. In addition, the individual fibers added to the slurry may be the same as, or different from, the reinforcing fibers forming the bundles of fibers depending on the desired end product. Because the amount of individual fibers added to the slurry can be controlled, the chopped strand mat may be fine tuned to meet the needs of a particular application. For example, enough single fibers may be added to the white water slurry to result in a mat with high tensile strength results but that can still meet the need to wet out with resin quickly when laminates are made from the mat. In general, the higher the weight percent of the individual fibers present in the white water slurry, the slower the wet out of the final chopped strand mat will be due to the overall higher surface area of the fibers to be wet out.

By selectively adjusting the permeability or degree of dispersion in the white water, the mat can be engineered to allow for the introduction of various fillers, such as calcium carbonate, talc, and/or other well-known mineral and/or organic fillers. The choice of fillers may be specific to a particular application and the specific filler incorporated into the chopped strand mat 10 may be chosen to enhance certain properties such as electric resistance and/or conductivity, or biodegradability of the chopped strand mat 10. The degree of dispersion allows for improved retention of these filler or additives. For example, the closed nature of the dispersed fibers would act as a screen to capture the fillers, and thus, depending on the degree of dispersion, a range of mats could be produced that could include lightly filled mats to highly filled mats with either large or small particle fillers. Such predetermined permeability may be used to improve physical properties such as acoustic absorption and surface erosion resistance.

The white water slurry containing the bundles of fibers and individual fibers may then be passed to a head box where the slurry is deposited onto a moving wire screen or mesh (forming wire) and a substantial portion of the water is removed to form a web. The presence of the individual fibers in the slurry are useful in the formation of the chopped strand mat because single fibers obtained from the glass fiber bundles and/or those individual reinforcement fibers added to the slurry assist in transferring the individual fibers and fiber bundles from the forming chain to the binder application section during the mat manufacturing process. The individual fibers entangle both with each other and with the fiber bundles and give the wet uncured mat “wet strength”. Although not wishing to be bound by theory, the amount of individual fibers needed to disperse (or to be added) such that an efficient and effective transfer of the slurry to the forming wire may be a “minimum” or threshold amount of individual fibers present in the chopped strand mat 10.

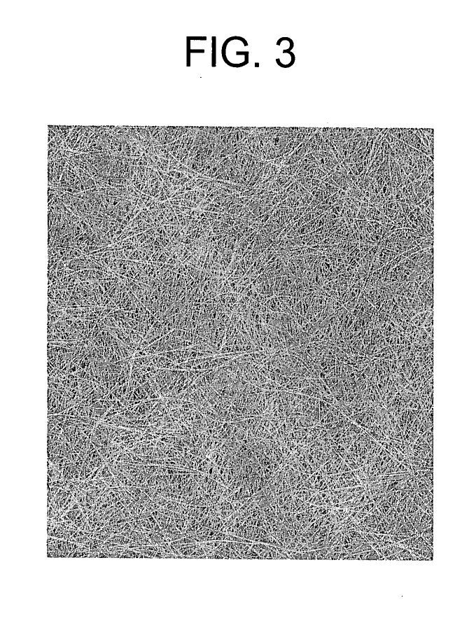

Due to the degree of dispersion of the fiber bundles and/or the amount of individual fibers added to the slurry, the web contains glass fiber bundles and individual glass fibers at a desired ratio and weight distribution. The water may be removed from the web by a conventional vacuum or air suction system. A binder is then applied to the web, and the resulting mat is heated (such as by an oven) to remove the remaining water and cure the binder. The formed non-woven chopped strand mat is an assembly of a pre-determined amount of randomly dispersed, individual glass fibers and glass fiber bundles such as is shown in FIG. 3.

The binder may be an acrylic binder, a styrene acrylonitrile binder, a styrene butadiene rubber binder, a urea formaldehyde binder, or mixtures thereof. Preferably, the binder is a standard thermosetting acrylic binder formed of polyacrylic acid and at least one polyol (e.g., triethanolamine or glycerine). Examples of suitable acrylic binders for use in the present invention include a plasticized polyvinylacetate binder such as Vinamul 8831 (available from Celenese) and modified polyvinylacetates such as Duracet 637 and Duracet 675 (available from Franklin International). The binder may optionally contain conventional additives for the improvement of process and product performance such as dyes, oils, fillers, colorants, UV stabilizers, coupling agents (e.g., silanes, aminosilanes, and the like), lubricants, wetting agents, surfactants, and/or antistatic agents. The binder may be supplied to the fibers at a rate such that the chopped strand mat contains about 2.5 to about 20% by weight binder.

The low-loft bundled chopped glass fiber mats are formed of fibers packed together along the fiber axis, which permits the chopped glass mat to have an increased glass content relative to conventional dispersed glass mats such as roofing mats. In addition, the retention of fiber bundles within the chopped strand mat allows for a higher glass content in the end use product. Because the chopped strand mat has an increased glass content, it is able to provide increased mechanical and impact performance and higher integrity in the final products. Higher structural integrity, in turn, results in improved surface quality due to the closed structure resulting from the dispersed fiber portion of the mat. The chopped strand mat of the present invention may be used to form surface treatments for products such as duct liners and ceiling tiles. In addition, the chopped strand mat may be used without the need to apply a secondary veil. Eliminating the need for the secondary, decorative surface veil would reduce manufacturing costs and increase productivity.

The chopped strand mat may also be used as a surfacing treatment or reinforcing layer for conventional “batt”, “blanket”, or “board” types of fibrous insulation. The chopped strand mat of the instant invention provides structural enhancement of the insulation due to the presence of the reinforcing fiber bundles in the mat and enhances the surface quality of the insulation due to the dispersion of the individual fibers throughout the mat. For conventional light density “batt” or “blanket” insulation, the structural strength added by the chopped strand mat is in the form of enhanced bending stiffness, or flexural strength. For higher density “board” insulation, the increased stiffness supplied by the chopped strand mat may also result in increased puncture resistance. Improved puncture resistance may be particularly advantageous for insulation boards utilized in heating and ventilation ducts. Further, by using a mat with a selective degree of permeability, the chopped strand mat would not only add stiffness to the insulation products but would also add air resistance to enhance noise absorption properties for acoustic applications.

Alternatively, the chopped strand mat could be positioned internally in the fibrous insulation and used as an internal septum. In such an embodiment, the chopped strand mat may be laminated between two layers of “batt” or “blanket” insulation to provide a reinforced insulative material. The chopped strand may also be positioned internally in the “batt” or “blanket” insulation by bisecting the insulation, positioning the chopped strand mat on one of the two sides of the bisected insulation, and re-joining the bisected insulation section together with the chopped strand mat (septum) positioned therebetween. Alternatively, the reinforcement fiber bundles could be intimately mixed with the bulk of the insulating fibers to give the insulation “batt” stiffness so that it would not sag between the studs in the walls and from overhead ceiling rafters. Such a reinforced insulation batt may not need to use supportive wires or other attachment devices to keep the insulation in place as is used with conventional insulation materials.

It is envisioned that when alkaline resistant glass (AR-type glass) is utilized as the reinforcing fiber or as one of the reinforcing fibers in the chopped strand mat, the chopped strand mat could be used as reinforcement to a concrete matrix. The combination of the reinforcement fiber bundles and individual reinforcement fibers in the chopped strand mat would serve the dual purpose of providing structural reinforcement and good surfacing properties to the concrete product.

It is also envisioned that the chopped strand mat could be utilized as a “geotextile” product. In such an application, the individual fibers within the chopped strand mat would permit an easy pick-up of any overspray such as seeds or mulch and would inhibit the growth of unwanted plants like weeds. The structural fiber bundles within the chopped strand mat would provide structural strength to limit tearing during the application of the mat and throughout its useful life.

Having generally described this invention, a further understanding can be obtained by reference to certain specific examples illustrated below which are provided for purposes of illustration only and are not intended to be all inclusive or limiting unless otherwise specified.

### EXAMPLES

The sizing formulations set forth in Tables 1-3 were prepared in buckets as described generally below. To prepare the size compositions, about 90% of the water and, if present in the size composition, the acid(s) were added to a bucket. The silane coupling agent was added to the bucket and the mixture was agitated for a period of time to permit the silane to hydrolyze. After the hydrolyzation of the silane, the lubricant and film former were added to the mixture with agitation to form the size composition. The size composition was then diluted with the remaining water to achieve the target mix solids of about 4.5% mix solids.

TABLE 1
Polyurethane Size Composition

| Component of Size | % by Weight of |
|---|---|
| Composition | Active Solids |
| W290H ^{(a)} | 83.64 |
| A-187 ^{(b)} | 1.12 |
| A-1100 ^{(c)} | 4.68 |
| A-100 ^{(d)} | 9.95 |
| Lubesize K-12 ^{(e)} | 0.61 |

^{(a)} polyurethane film forming dispersion (Cognis)
^{(b)} epoxy curative (Resolution Performance Products)
^{(c)} γ-aminopropyltriethoxysilane (General Electric)
^{(d)} polyurethane-acrylic alloy (Cognis)
^{(e)} stearic ethanolamide (AOC)

TABLE 2
Epoxy Size Composition A

| Component of Size | % by Weight of |
|---|---|
| Composition | Active Solids |
| ER 5520^{(a)} | 46.15 |
| DPC-6870^{(b)} | 46.15 |
| PEG 400 MO^{(c)} | 1.08 |
| A-174^{(d)} | 4.62 |

^{(a)}epoxy resin film forming dispersion in water (Resolution Performance Products)
^{(b)}epoxy curative (Resolution Performance Products)
^{(c)}monooleate ester (Cognis)
^{(d)}methacryloxypropyltrimethoxysilane (General Electric)

TABLE 3
Epoxy Size Composition D

| Component of Size | % by Weight of |
|---|---|
| Composition | Active Solids |
| ER 3546^{(a)} | 46.15 |
| DPC-6870^{(b)} | 46.15 |
| PEG 400 MO^{(c)} | 1.08 |
| A-174^{(d)} | 4.62 |

^{(a)}epoxy resin film forming dispersion (Resolution Performance Products)
^{(b)}epoxy curative (Resolution Performance Products)
^{(c)}monooleate ester (Cognis)
^{(d)}methacryloxypropyltrimethoxysilane (General Electric)

Each of the sizes were applied to E-glass in a conventional manner (such as a roll-type applicator as described above) and used to form a chopped strand mat. The strand was split into bundles having a tex of 40 g/km chopped to 1¼ inch chop length and collected in plastic tubs. The glass bundles were then dried in a commercial-grade 40 MHz RF oven for about 30 minutes. The glass fiber bundles (with essentially 0% moisture) was added to a large slurry tank in which the appropriate additives (surfactants, dispersants, and the like) were added. The components of the white water slurry (other than water) are set forth in Table 4

TABLE 4

| White Water | Amount |
|---|---|
| Components | (ppm) |
| Drewfloc 270^{(a)} | 400-900 |
| Surfynol 465^{(b)} | 50-200 |
| Drew L-139^{(c)} | 5-25 |
| Nalco 7330^{(d)} | 1-5 |

^{(a)}anionic polyacrylamide (available from Drew Industries)
^{(b})nonionic surfactant (available from Air Products)
^{(c)}antifoaming agent (available from Drew Industries
^{(d)}biocide (ONDEO Nalco)

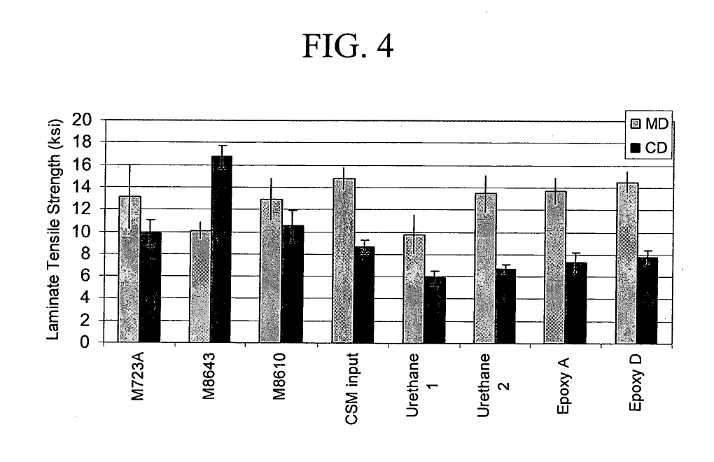

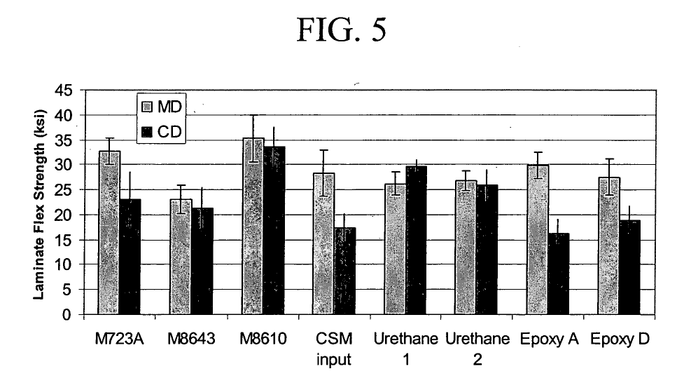

The process mimic equipment was set so the bundles were thoroughly mixed in the white water for 5 minutes. The glass-water slurry was pumped to the headbox, where it was transferred onto the wet-web forming chain (which traveled from approximately 10-50 fpm). The slurry was transferred through the head box to the forming wire, then to the binder chain. 5% Vinamul 8831 was applied to the web and the web was dried at 450° F. for 20 seconds. The mats formed from the epoxy size compositions A and D set forth in Tables 2 and 3 respectively had a basis weight of 1 oz/ft². The polyurethane size composition set forth in Table 1 was used to form a mat with a basis weight of 0.5 oz/ft² and a mat with a basis weight of 1.5 oz/ft². In FIGS. 4 and 5, Urethane 1 designates an inventive mat with a basis weight of 0.5 oz/ft² and Urethane 2 designates an inventive mat with a basis weight of 1.5 oz/ft².

The mats were then rolled up onto a cardboard tube and cut into 1 foot×1 foot pieces. Pieces of the cut mats were placed into a heated tool on a 100 ton press. A catalyzed polyester resin (AOC H93) was poured onto the mats and the press was closed for 20 minutes at 200° F. The laminates were prepared with a total of 3 oz/ft² basis weight of the glass mat.

The molded laminates were removed and tested for tensile strength and flexural strength. The tensile strength was determined according to the testing procedures set forth in ASTM D5083 and flexural strength was determined according to the testing procedures set forth in ASTM D790. The inventive mats were compared the tensile strength and flexural strength of the mats set forth in Table 5.

TABLE 5

| Conventional | |
|---|---|
| Mat | Description |
| M723 | 1 oz/ft² chopped strand mat from Owens Corning |
| M8643 | 1 oz/ft² electrical-pultrusion grade continuous |
| | filament mat from Owens Corning |
| M8610 | 1 oz/ft² general purpose continuous filament mat |
| | from Owens Corning |
| CSM Input | 1 oz/ft² conventional chopped strand mat formed in |
| | a wet process mimic line from Owens Corning |

The results of the laminate tensile strength testing and the laminate flexural strength testing in both the machine direction (MD) and the cross direction (CD) are set forth graphically in FIGS. 4 and 5 respectively. One of skill in the art would expect a continuous filament mat such as M8643 and M8610 from Owens Coming to outperform conventional chopped strand mats because they are made of continuous strands. However, the laminates formed from the inventive chopped strand mats demonstrated mechanical properties that were substantially equal to or better than the laminates formed from conventional mats. In particular, the inventive chopped strand mat laminates demonstrated mechanical properties within ±10% of the standard values for M723A, M8643, M8610, and the CSM Input chopped strand mats available from Owens Corning. Thus, it can be concluded that the experimental mats containing the inventive size compositions had excellent tensile strength and flexural strength and had desirable performance qualities relative to the standard mats from Owens Corning.

Other sizes were also investigated and found to be useful in the present invention. Examples of these size composition are set forth in Tables 6-15 below.

TABLE 6
Size 1

| Component of Size | % by Weight of |
|---|---|
| Composition | Active Solids |
| Neoxil 6158 ^{(a)} | 85.16 |
| Lubesize K-12 ^{(b)} | 9.52 |
| A-1100 ^{(c)} | 4.70 |
| A-100 ^{(d)} | 0.63 |

^{(a)} polyurethane film forming dispersion (DSM)
^{(b)} stearic ethanolamide (AOC)
^{(c)} γ-aminopropyltriethoxysilane (General Electric)
^{(d)} polyurethane-acrylic alloy (Cognis)

TABLE 7
Size 2

| Component of Size | % by Weight of |
|---|---|
| Composition | Active Solids |
| PE 412 ^{(a)} | 82.91 |
| Benox L-40LV ^{(b)} | 9.75 |
| PEG 400 MO ^{(c)} | 0.83 |
| A-174 ^{(d)} | 6.50 |

^{(a)} polyester resin film forming dispersion (AOC)
^{(b)} benzoyl peroxide curing catalyst (Norac Company, Inc.)
^{(c)} monooleate ester (Cognis)
^{(d)} methacryloxypropyltrimethoxysilane (General Electric)

TABLE 8
Size 3

| Component of Size | % by Weight of |
|---|---|
| Composition | Active Solids |
| Neoxil 2105 ^{(a)} | 82.91 |
| Benox L-40LV ^{(b)} | 9.75 |
| PEG 400 MO ^{(c)} | 0.83 |
| A-174 ^{(d)} | 6.50 |

^{(a)} polyester resin film forming dispersion (DSM)
^{(b)} benzoyl peroxide curing catalyst (Norac Company, Inc.)
^{(c)} monooleate ester (Cognis)
^{(d)} methacryloxypropyltrimethoxysilane (General Electric)

TABLE 9
Size 4

| Component of Size | % by Weight of |
|---|---|
| Composition | Active Solids |
| Neoxil 954D ^{(a)} | 82.91 |
| Benox L-40LV ^{(b)} | 9.75 |
| PEG 400 MO ^{(c)} | 0.83 |
| A-174 ^{(d)} | 6.50 |

^{(a)} polyester resin film forming dispersion (DSM)
^{(b)} benzoyl peroxide curing catalyst (Norac Company, Inc.)
^{(c)} monooleate ester (Cognis)
^{(d)} methacryloxypropyltrimethoxysilane (General Electric)

TABLE 10
Size 5

| Component of Size | % by Weight of |
|---|---|
| Composition | Active Solids |
| Neoxil PS 4759 ^{(a)} | 82.91 |
| Benox L-40LV ^{(b)} | 9.75 |
| PEG 400 MO ^{(c)} | 0.83 |
| A-174 ^{(d)} | 6.50 |

^{(a)} polyester resin film forming dispersion (DSM)
^{(b)} benzoyl peroxide curing catalyst (Norac Company, Inc.)
^{(c)} monooleate ester (Cognis)
^{(d)} methacryloxypropyltrimethoxysilane (General Electric)

TABLE 11
Size 6

| Component of Size | % by Weight of |
|---|---|
| Composition | Active Solids |
| Neoxil 962D ^{(a)} | 46.15 |
| DPC 6870 ^{(b)} | 46.15 |
| PEG 400 MO ^{(c)} | 3.08 |
| A-174 ^{(d)} | 4.62 |

^{(a)} epoxy resin film forming dispersion (DSM)
^{(b)} epoxy curative (Resolution Performance Products)
^{(c)} monooleate ester (Henkel Chemicals)
^{(d)} methacryloxypropyltrimethoxysilane (General Electric)

TABLE 12
Size 7

| Component of Size | % by Weight of |
|---|---|
| Composition | Active Solids |
| Neoxil 0151 ^{(a)} | 46.15 |
| DPC 6870 ^{(b)} | 46.15 |
| PEG 400 MO ^{(c)} | 3.08 |
| A-174 ^{(d)} | 4.62 |

^{(a)} epoxy resin film forming dispersion (DSM)
^{(b)} epoxy curative (Resolution Performance Products)
^{(c)} monooleate ester (Cognis)
^{(d)} methacryloxypropyltrimethoxysilane (General Electric)

TABLE 13
Size 8

| Component of Size | % by Weight of |
|---|---|
| Composition | Active Solids |
| Neoxil 2762 ^{(a)} | 46.15 |
| DPC 6870 ^{(b)} | 46.15 |
| PEG 400 MO ^{(c)} | 3.08 |
| A-174 ^{(d)} | 4.62 |

^{(a)} epoxy resin film forming dispersion (DSM)
^{(b)} epoxy curative (Resolution Performance Products)
^{(c)} monooleate ester (Cognis)
^{(d)} methacryloxypropyltrimethoxysilane (General Electric)

TABLE 14
Size 9

| Component of Size | % by Weight of |
|---|---|
| Composition | Active Solids |
| NX 1143 ^{(a)} | 46.15 |
| DPC 6870 ^{(b)} | 46.15 |
| PEG 400 MO ^{(c)} | 3.08 |
| A-174 ^{(d)} | 4.62 |

^{(a)} epoxy resin film forming dispersion (DSM)
^{(b)} epoxy curative (Resolution Performance Products)
^{(c)} monooleate ester (Cognis)
^{(d)} methacryloxypropyltrimethoxysilane (General Electric)

TABLE 15
Size 10

| Component of Size | % by Weight of |
|---|---|
| Composition | Active Solids |
| AD 502 ^{(a)} | 46.15 |
| DPC 6870 ^{(b)} | 46.15 |
| PEG 400 MO ^{(c)} | 3.08 |
| A-174 ^{(d)} | 4.62 |

^{(a)} epoxy resin film forming dispersion (AOC)
^{(b)} epoxy curative (Resolution Performance Products)
^{(c)} monooleate ester (Cognis)
^{(d)} methacryloxypropyltrimethoxysilane (General Electric)

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A non-woven chopped strand mat comprising:
a first predetermined amount of fiber bundles formed of a plurality of individual first reinforcement fibers; and
a second predetermined amount of said individual first reinforcement fibers, said individual first reinforcement fibers being at least partially coated with a size composition that selectively disperses said individual first reinforcement fibers from said fiber bundles in said second predetermined amount during the formation of said chopped strand mat, and
wherein said first and second predetermined amounts are the same or different.

2. The non-woven chopped strand mat of claim 1, wherein said size composition comprises:
one or more film forming agents selected from at least one of a polyurethane film former, an unsaturated polyester film former and an epoxy resin film former;
at least one silane coupling agent; and
at least one lubricant.

3. The non-woven chopped strand mat of claim 2, wherein said film forming agent is a polyurethane film forming agent and said size composition further comprises a polyurethane-acrylic alloy.

4. The non-woven chopped strand mat of claim 2, wherein said film forming agent is an epoxy resin film former and said size composition further comprises an epoxy curative.

5. The non-woven chopped strand mat of claim 2, wherein said film forming agent is an unsaturated polyester film forming agent and said size composition further comprises a benzoyl peroxide curing catalyst.

6. The non-woven chopped strand mat of claim 2, further comprising a third predetermined amount of a second individual reinforcement fiber.

7. The non-woven chopped strand mat of claim 1, wherein said size composition further disperses said fiber bundles into said plurality of individual first reinforcement fibers during subsequent processing of said chopped strand mat into a final product.

8. The non-woven chopped strand mat of claim 7, wherein said second predetermined amount is substantially zero.

9. The non-woven chopped strand mat of claim 8, further comprising a third predetermined amount of second individual reinforcement fibers.

10. A wet-laid method of forming a non-woven chopped strand mat that includes bundles of reinforcement fibers and individual reinforcement fibers comprising the steps of:
drying chopped reinforcement fiber bundles formed of individual first reinforcement fibers having a size composition on at least a portion thereof to consolidate said size composition on said first reinforcement fibers to form dried bundles of first reinforcement fibers;
depositing a first predetermined amount of said dried bundles of first reinforcement fibers in a water slurry;
agitating said slurry to disperse said bundles of first reinforcement fibers and selectively release a second predetermined amount of individual first reinforcement fibers from said bundles of first reinforcement fibers;
forming a web of said bundles of first reinforcement fibers and said individual first reinforcement fibers;
applying a binder composition to said web; and
heating said web to dry said web and cure said binder composition and form a chopped strand mat that includes said bundles of first reinforcement fibers in said first predetermined amount and said individual first reinforcement fibers in said second predetermined amount.

11. The wet-laid method of claim 10, further comprising the steps of:
gathering first reinforcement fibers into fiber bundles formed of said first reinforcement fibers; and
chopping said fiber bundles to a discrete length to form said chopped reinforcement fiber bundles prior to said drying step.

12. The wet-laid method of claim 11, further comprising the steps of:
forming first reinforcement fibers; and
applying said size composition to said first reinforcement fibers prior to said gathering step.

13. The wet-laid process of claim 12, wherein said size composition comprises:
one or more film forming agents selected from at least one of a polyurethane film former, an unsaturated polyester film former and an epoxy resin film former;
at least one lubricant; and
at least one silane coupling agent.

14. The wet-laid method of claim 10, wherein said drying step comprises:
passing said chopped reinforcement fiber bundles through an oven selected from at least one of a dielectric oven, a fluidized bed oven and a rotating tray thermal oven.

15. The wet-laid method of claim 10, further comprising the step of:
adding individual second reinforcement fibers to said water slurry prior to said forming step, said second reinforcement fibers being different from said first reinforcement fibers.

16. A wet-laid method of forming a non-woven chopped strand mat that includes bundles of reinforcement fibers and individual reinforcement fibers comprising the steps of:
drying chopped reinforcement fiber bundles formed of individual first reinforcement fibers having a size composition on at least a portion thereof to consolidate said size composition on said first reinforcement fibers to form dried bundles of first reinforcement fibers;
adding a first predetermined amount of said dried bundles of first reinforcement fibers to a white water slurry;
adding a second predetermined amount of individual second reinforcement fibers to said white water slurry;
agitating said slurry to disperse said bundles of first reinforcement fibers and said individual second reinforcement fibers throughout said white water slurry;
forming a web of said bundles of first reinforcement fibers and said individual second reinforcement fibers;
applying a binder composition to said web; and
heating said web to dry said web and cure said binder composition and form a chopped strand mat that includes said bundles of first reinforcement fibers in said first predetermined amount and said individual second reinforcement fibers in said second predetermined amount.

17. The wet-laid method of claim 16, further comprising the steps of:
gathering first reinforcement fibers into bundles of first reinforcement fibers; and
chopping said bundles of first reinforcement fibers to a discrete length to form said chopped reinforcement fiber bundles prior to said drying step.

18. The wet-laid method of claim 17, further comprising the steps of:
forming first reinforcement fibers; and
applying a size composition to said first reinforcement fibers prior to said gathering step.

19. The wet-laid process of claim 16, wherein said size composition comprises:
one or more film forming agents selected from at least one of a polyurethane film former, an unsaturated polyester film former and an epoxy resin film former;
at least one lubricant; and
at least one silane coupling agent.

20. The wet-laid method of claim 19, wherein said drying step comprises:
passing said sized chopped reinforcement fiber bundles through an oven selected from the group consisting of a dielectric oven, a fluidized bed oven and a rotating tray thermal oven.
